(19) United States
(12) Patent Application Publication
(10) Pub. No.: US 2010/0191788 A1
(43) Pub. Date: Jul. 29, 2010

(54) Multiplier with Shifter

(76) Inventor: Laurent Le-Faucheur, Antibes (FR)

Correspondence Address: TEXAS INSTRUMENTS INCORPORATED, P O BOX 655474, M/S 3999, DALLAS, TX, 75265, US

(21) Appl. No.: 12/493,211

(22) Filed: Jun. 28, 2009

(30) Foreign Application Priority Data
Jan. 27, 2009 (EP) EP 09 290 057.0

(51) Int. Cl. G06F 7/52; G06F 7/00; G06F 17/10

(52) U.S. Cl. 708/209; 708/300; 708/620

(57) ABSTRACT

A digital system has a memory configured to hold operands and a multiply-shift unit coupled to the memory and configured to receive a first operand and a second operand from the memory in parallel, wherein the first operand includes a concatenated encoded shift amount. The multiply-shift unit includes a multiplier configured to receive the first operand after being separated from the concatenated encoded shift amount and to form a quotient from the two operands. A shifter is coupled to receive the quotient and to shift the quotient by an amount indicated by the encoded shift amount and to thereby form a shifted quotient on an output of the multiply-shift unit.

### CLAIM OF PRIORITY

This application for Patent claims priority to European Patent Application No. EP 09 290 057.0 (attorney docket TI-67084EP) entitled “Multiplier with Shifter” filed Jan. 27, 2009 and incorporated by reference herein.

### FIELD OF THE INVENTION

This invention generally relates to the field of digital signal processing, and more particularly to the implementation of digital filters and more specifically recursive filters such as infinite impulse response filters.

### BACKGROUND OF THE INVENTION

Mobile audio devices are a ubiquitous fixture of modern society. Cellular telephones, personal music players, portable gaming systems, etc. are constant companions for many people. Cell phones continue to increase in computer processing capability and sophistication. The increased memory capacity and computing resources on a cell phone support the installation of various applications, often referred to as “apps” that allow a diverse range of functions to be performed by the cell phone when not being used for conversation.

For example, even when not talking, social networking can continue using various messaging tools and features. A wide circle of friends can be kept current with a twittering app. Shopping venues can be located and found using navigation apps that provide mapping and global positioning system (GPS) functionality. Various game apps use the keyboard and display to provide a range of gaming opportunities.

Central to the operation of a cell phone and many of the apps placed on a cell phone is digital signal processing. Digital filters are used for modulation, demodulation, frequency separation and extraction, wave shaping and a host of other functions. The general theory and operation of digital filters is well known; for example, see “Digital Signal Processing for Measurement Systems, Theory and Applications,” Gabriele D'Antona and Alessandro Ferrero, 2006.

Many other types of devices, both mobile and fixed, also rely on digital signal processing to implement digital filters for a wide range of functions.

### BRIEF DESCRIPTION OF THE DRAWINGS

Particular embodiments in accordance with the invention will now be described, by way of example only, and with reference to the accompanying drawings:

FIG. 1 is an illustrative recursive infinite impulse filter that may be embodied using a multiplier with shifter which embodies an aspect of the present invention;

FIG. 2 is a block diagram of a multiplier with shifter;

FIG. 3 is a block diagram representative of two or more multipliers with shifters;

FIG. 4 is a flow chart illustrating operation of a multiplier with shifter; and

FIG. 5 is a block diagram illustrating operation of a compiler; and

FIG. 6 is a more detailed block diagram of a cell phone that embodies a multiplier with shifter.

### DETAILED DESCRIPTION OF EMBODIMENTS OF THE INVENTION

Digital signal processing typically involves multiplying two operands together to form a quotient and then adding the quotient to a running value that is retained in an accumulator. This common function is referred to as “multiply-accumulate.” In order to prevent overflow, a shifter may be included with the multiplier for scaling the quotient. In order to allow the amount of shift to be dynamically specified, an encoded shift amount is concatenated with one of the operands. When the operand is received at the multiplier, the encoded shift amount is stripped from the operand and used to control the quotient shifter. In this manner, the multiply and shift operation may be performed in one clock cycle, as will be described in more detail below.

Digitals filters are often described and implemented in terms of a difference equation that defines how the output signal is related to the input signal:

$$y [ n ] = \frac{1}{{a}_{0}} ( {b}_{0} x [ n ] + {b}_{1} x [ n - 1 ] + … + {b}_{P} x [ n - P ] - {a}_{1} y [ n - 1 ] - {a}_{2} y [ n - 2 ] - … - {a}_{Q} y [ n - Q ] )$$

where:

P is the feedforward filter order

bᵢ are the feedforward filter coefficients

Q is the feedback filter order

aᵢ are the feedback filter coefficients

x[n] is the input signal

y[n] is the output signal.

A more condensed form of the difference equation is:

$$y [ n ] = \frac{1}{{a}_{0}} ( {\sum }_{i = 0}^{P} {b}_{i} x [ n - i ] - {\sum }_{j = 1}^{Q} {a}_{j} y [ n - j ] )$$

which, when rearranged, becomes:

$${\sum }_{j = 0}^{Q} {a}_{j} y [ n - j ] = {\sum }_{i = 0}^{P} {b}_{i} x [ n - i ]$$

To find the transfer function of the filter, a Z-transform of each side of the above equation is taken, where the time-shift property is used to obtain:

$${\sum }_{j = 0}^{Q} {a}_{j} {z}^{- j} Y ( z ) = {\sum }_{i = 0}^{P} {b}_{i} {z}^{- i} X ( z )$$

The transfer function is defined to be:

$$H ( z ) = \frac{Y ( z )}{X ( z )} = \frac{{\sum }_{i = 0}^{P} {b}_{i} {z}^{- i}}{{\sum }_{j = 0}^{Q} {a}_{j} {z}^{- j}}$$

Considering that in most IIR filter designs coefficient a₀ is 1, the IIR filter transfer function takes the more traditional form:

$$H ( z ) = \frac{{\sum }_{i = 0}^{P} {b}_{i} {z}^{- i}}{1 + {\sum }_{j = 1}^{Q} {a}_{j} {z}^{- j}}$$

FIG. 1 is an illustrative recursive infinite impulse filter 100 that may be embodied using a multiplier with shifter which embodies an aspect of the present invention. IIR 100 has a third order feedforward section and a third order feedback section. The feedforward section receives the stream of digital samples 102 and applies the forward coefficients bₙ, indicated generally at 110(1), 110(3). A feedback section receives the output of the feedforward section and applies the feedback coefficients aₙ, indicated generally at 120(1), 120(3). The z⁻¹ blocks 112, 122 represent unit delays.

A problem occurs in the implementation of digital filters, and more specially recursive filters which are used to form infinite impulse response filters (IIR), due to the fact that IIR filters have coefficients that can result in overflows in the adders 130 because of the gain introduced by the filter. This typically occurs in the feedback section.

For example, an exemplary elliptic low-pass filter expressed in MATLAB syntax is [b,a]=ellip(6, 0.1, 80, 0.1). The resulting direct-form coefficients are listed in Table 1.

TABLE 1
Filter coefficient example

| | |
|---|---|
| Numerator | 0.00025133948119 |
| | −0.00061842221134 |
| | 0.00097323498511 |
| | −0.00102928636188 |
| | 0.00097323498511 |
| | −0.00061842221134 |
| | 0.00025133948119 |
| Denominator | 1.00000000000000 |
| | −5.32262562108146 |
| | 11.96148373546689 |
| | −14.51484269034522 |
| | 10.02440650968738 |
| | −3.73420348473867 |
| | 0.58596668840939 |

The denominator operations translates to:

Y(output)=X(input)+5.322×Z−1−11.961×Z−1+14.51×Z−3 . . .

The denominator is the recursive part of the filter, and several of the coefficients are larger than one. One way to cope with this problem is to lower the amplitude of the input signal by scaling it down. However, this results in increasing the quantization noise floor. Another way is to lower the values of the coefficients, however, this leads to poor filter performance due to smaller useful bits per coefficient, and can lead to instabilities.

If all of the coefficients are scaled, then in this example they would all be scaled with a division by 16 which is the smallest power of two larger than the highest coefficient −14.514 . . . . As mentioned above, this results in poorer filter performance because four bits of coefficient accuracy is lost because of the scaling and an additional shift+16 instruction is required in order to restore the original scale. Alternatively, the input data samples could be scaled down to preserve the coefficients precision, but this would add quantization floor noise on the data.

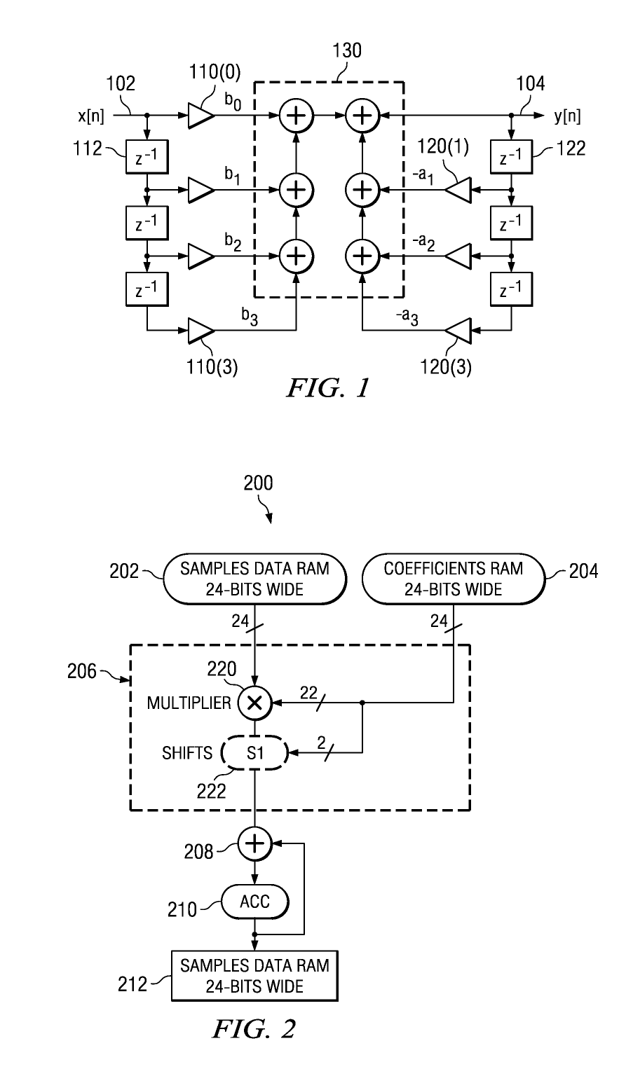

FIG. 2 is a block diagram of a portion 200 of a digital system that includes multiply-shift block 206 that has a multiplier 220 coupled to shifter 222. In this embodiment of the invention, the data samples are stored in samples data random access memory (RAM) 202 and the filter coefficients are stored in coefficients RAM 204, both of which are 24-bits wide. A floating point representation may be used to represent the coefficients as floating point numbers with a mantissa and exponent. In this embodiment of the invention, the precision of the coefficient is reduced by only two bits and an encoded shift amount is concatenated with the reduced coefficient and stored in coefficients RAM 204 as coefficient data.

Each pair of sample data and coefficient is accessed from RAM 202 and RAM 204 respectively and received by multiply-shift block 206. The encoded shift amount is separated from the coefficient data. The multiplication of the mantissa is done in multiplier 220 with the remaining 22-bits of coefficient and shifter 222 then implements amplitude scaling to prevent overflow. In this embodiment, multiplier 220 may be implemented as a 24×22 multiplier to save circuitry. The two bits of encoded shift amount that are separated from the coefficient data are decoded and used to control shifter 222. Since each time the next coefficient data is accessed from RAM an encoded shift amount is also included, the shift amount can be different for each multiply operation. Thus, the multiply and shift may be performed in a single clock cycle with an individually selected shift amount.

For example, in one embodiment, shift values of +6, +1, 0, and −6 may be encoded in two bits as 11, 10, 01, and 00. The 2 least significant bits (LSB) of the coefficients are used to tune the shifter. 24-bits from the coefficient memory are split into a 22-bit mantissa to the multiplier and 2-bits to the post-shifter 222. In another embodiment shift values of +4, +1, 0, and −6 may be encoded in two bits as 11, 10, 01, and 00, for example. In another embodiment, the encodings may be in a different order. In other embodiments, various combinations of shift amount may be encoded in two bits. In other embodiment, various combinations of shift amount may be encoded in three or more bits. In some embodiments, a single bit may be used to encode two shift amount values.

Referring again to the example above, from Table 1 the second denominator coefficient is 5.32262562108146 which may be represented in 24-bit binary as 101010100101001011110010. The two bits shift values of the coefficients (two LSBs) are defined at compilation time. In this example, assume the encoded shifts are +4, +1, 0, −6 respectively coded with “11, “10”, “01” and “00”.

In order to implement Y=Y×C (C=5.32262562108146), without using the concatenated shift amount feature described above, one option is to code C with scaling to the closest power of 2 (here 2<<3=8): C0=010101010010100101111001 and an extra instruction is needed to rescale the result by three bits. For an ALU with an accumulator with at least three guard bits an example instruction sequence may be:

ACC=Y×C0, followed by

ACC=ACC<<3

If a generic filtering subroutine is used, then an independent shift value can not be used for each coefficient but the worst case situation must be used instead. In this example, the largest coefficient is 14.51 so the scaling will be 4. C1 is now C1=001010101001010010111100 and the code is:

ACC=Y×C1, followed by

ACC=ACC<<4

The complete filter is a succession of similar code.

Referring again to FIG. 2 in which the multiply-shift unit supports a concatenated encoded shift amount, an improved option is to encode C as: C2=0010101010010100101111(11), where the two LSB contain “11” which is the encoded shift amount indicative of a shift of +4. In this improved case, the code is simply:

ACC=(Y×C2)<<4

Thus, the coefficients may be individually scaled. The input signal does not need to be scaled and the quantization noise of the signal is therefore not increased. Using this shifter capability allows the size of the multiplier to be reduced to a 24×22 configuration instead of 24×24 without loosing accuracy in the filter computations.

As each shifted quotient is produced on the output of multiply-shift unit 206, adder 208 adds it to the running value stored in accumulator 210. At the completion of one filter iteration the output sample value is then stored into sample data RAM 212, which may be the same as RAM 202.

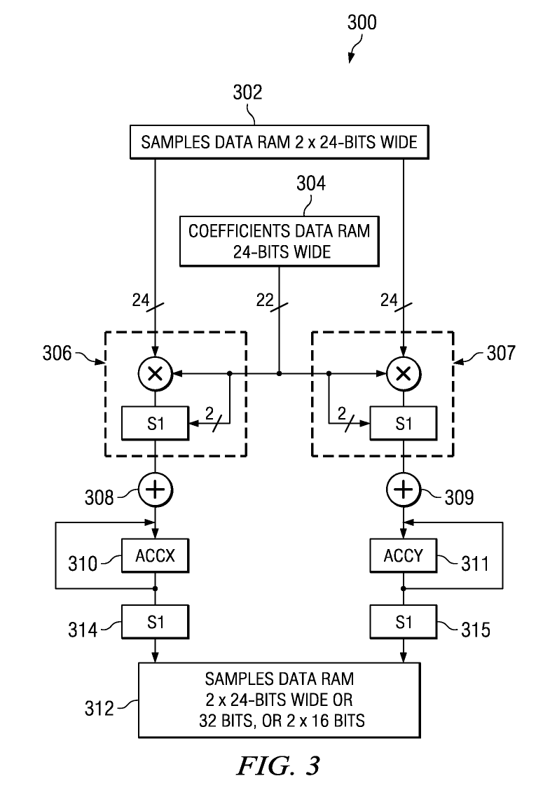

FIG. 3 is a block diagram representative of a portion 300 of a digital system that includes two or more multipliers with shifters 306, 307. In this embodiment, two or more filter iterations may be performed in parallel. Data sample RAM 302 is organized to produce two data samples on each access that are then sent respectively to multiply-shift units 306,307. A common coefficient data is accessed from RAM 304 and provided to both multiply-shift units. As described above, the encoded shift amount is separated from the coefficient data. The multiplication of the mantissa is done in each multiplier with the remaining 22-bits of coefficient and each post shifter then implements amplitude scaling to prevent overflow. In this embodiment, each multiplier may be implemented as a 24×22 multiplier to save circuitry. The two bits of encoded shift amount that are separated from the coefficient data are decoded and used to control both post-shifters. Since each time the next coefficient data is accessed from RAM an encoded shift amount is also included, the shift amount can be different for each multiply operation. Thus, the multiply and shift may be performed in a single clock cycle with an individually selected shift amount.

As each shifted quotient is produced on the output of each multiply-shift unit 306, 307 adder 308, 309 respectively, adds it to the running value stored in accumulators 310, 311 respectively. At the completion of one filter iteration the output sample values are then stored into sample data RAM 312, which may be the same as RAM 302. In this embodiment, an additional set of shifters 314, 315 is provided to allow data normalization, for example.

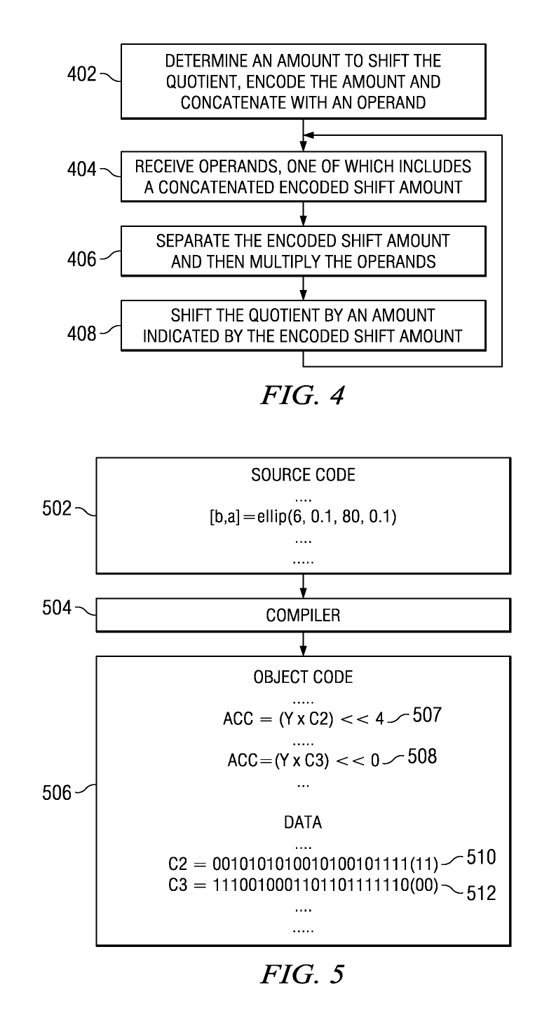

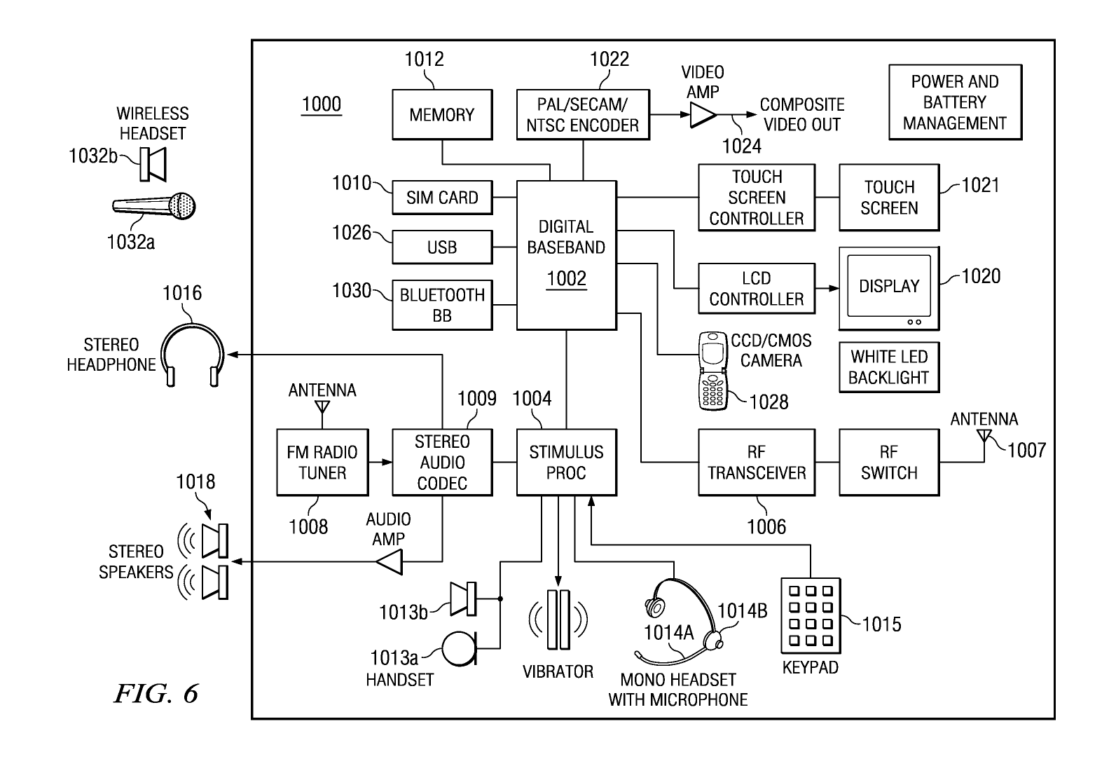

FIG. 4 is a flow chart illustrating operation of a multiplier with shifter as described above. A compiler may determine 402 an amount to shift the quotient for each coefficient. The shift amount is selected from a set of shift amounts that can be encoded into two bits, for example. For example, in one embodiment, shift values of +6, +1, 0, and −6 may be encoded in two bits as 11, 10, 01, and 00. The encoded value of the selected amount of shift is then concatenated with the coefficient operand that will be multiplied with the sample data. In this embodiment, two LSBs are dropped from the coefficient operand and replaced by the encoded shift amount.

Each pair of sample data and coefficient is accessed from memory and received 404 by a multiply-shift unit. The coefficient operand includes the encoded shift amount. The encoded shift amount is separated 406 from the coefficient data. The multiplication 406 of the mantissa is done with the remaining 22-bits of coefficient and the 24-bit sample data operand.

The quotient is then shifted 408 according to the encoded shift amount to form a shifted quotient on an output of the multiply-shift unit. In this manner, amplitude scaling of the quotient is implemented to prevent overflow.

FIG. 5 is a block diagram illustrating operation of a compiler that compiles code and data to operate the multiply-shift unit of FIG. 2, for example. Source code 502 is prepared that includes syntax for an IIR filter, as described above. The source code is provided to a compiler 504. The compiler generates an object module 506 using generally known compiler techniques. The compiler determines the filter coefficients based on the source code syntax. In this example, a data table represented at 510, 512 is created that holds the contents of Table 1.

However, as was described above, the compiler is also configured to determine how much shift is required for each coefficient in Table 1 to prevent overflow. The compiler is configured to encode an amount of shift selected from a set of shift values and to concatenate the encoded shift amount onto each coefficient, as indicated in (nn) at 510, 512. The compiler then generates object code 507, 508 that instructs a multiply-shift unit as described with respect to FIG. 2 to perform a multiply operation. The amount of shift performed by the multiply-shift unit is defined by the encoded shift amount in each coefficient 510, 512, etc.

### System Example

FIG. 10 is a block diagram of mobile cellular phone 1000 for use in a cellular network. Digital baseband (DBB) unit 1002 can include a digital processing processor system (DSP) that includes embedded memory and security features. Stimulus Processing (SP) unit 1004 receives a voice data stream from handset microphone 1013a and sends a voice data stream to handset mono speaker 1013b. SP unit 1004 also receives a voice data stream from microphone 1014a and sends a voice data stream to mono headset 1014b. Usually, SP and DBB are separate ICs. In most embodiments, SP performs processing based on configuration of audio paths, filters, gains, etc being setup by software running on the DBB. In an alternate embodiment, SP processing is performed on the same processor that performs DBB processing. In another embodiment, a separate DSP or other type of processor performs SP processing.

RF transceiver 1106 is a digital radio processor and includes a receiver for receiving a stream of coded data frames from a cellular base station via antenna 1107 and a transmitter for transmitting a stream of coded data frames to the cellular base station via antenna 1107. RF transceiver 1106 is connected to DBB 1102 which provides processing of the frames of encoded data being received and transmitted by cell phone 1100.

DBB unit 1002 may send or receive data to various devices connected to universal serial bus (USB) port 1026. DBB 1002 can be connected to subscriber identity module (SIM) card 1010 and stores and retrieves information used for making calls via the cellular system. DBB 1002 can also connected to memory 1012 that augments the onboard memory and is used for various processing needs. DBB 1002 can be connected to Bluetooth baseband unit 1030 for wireless connection to a microphone 1032a and headset 1032b for sending and receiving voice data. DBB 1002 can also be connected to display 1020 and can send information to it for interaction with a user of the mobile UE 1000 during a call process. Display 1020 may also display pictures received from the network, from a local camera 1026, or from other sources such as USB 1026. DBB 1002 may also send a video stream to display 1020 that is received from various sources such as the cellular network via RF transceiver 1006 or camera 1026. DBB 1002 may also send a video stream to an external video display unit via encoder 1022 over composite output terminal 1024. Encoder unit 1022 can provide encoding according to PAL/SECAM/NTSC video standards. In some embodiments, audio codec 1109 receives an audio stream from FM Radio tuner 1108 and sends an audio stream to stereo headset 1116 and/or stereo speakers 1118. In other embodiments, there may be other sources of an audio stream, such a compact disc (CD) player, a solid state memory module, etc.

As described in more detail above, DBB unit 1002 contains a multiply-shift unit that is configured to receive two operands on respective inputs of the multiply-shift unit, wherein one of the operands includes a concatenated encoded shift amount, multiply the two operands to form a quotient after separating the concatenated encoded shift amount from the one operand, and shift the quotient according to the encoded shift amount to form a shifted quotient on an output of the multiply-shift unit.

### Other Embodiments

While the invention has been described with reference to illustrative embodiments, this description is not intended to be construed in a limiting sense. Various other embodiments of the invention will be apparent to persons skilled in the art upon reference to this description. For example, while a 24-bit sample data size and coefficient size was described herein, multiply-shift units that operate on other sizes of operands and coefficients may be easily embodied using the techniques described herein.

While embodiments of the invention were described for implementing IIR filters herein, other types of digital signal processing may make use of various embodiments of a multiply-shift unit responsive to encoded shift amounts as described herein.

The multiply-shift unit may be a scalar multiplier instead of a floating point unit. While one or two units in parallel were illustrated herein, a system with more than two multiply-shift units in parallel may be embodied using the concepts described herein.

While a mobile handset has been described, embodiments of the invention are not limited to cellular phone devices. Various personal devices such as audio players, video players, radios, televisions, personal digital assistants (PDA) may use an embodiment of the invention to perform digital signal processing for various application provided by the device.

Although the invention finds particular application to systems using Digital Signal Processors (DSPs), implemented, for example, in an Application Specific Integrated Circuit (ASIC), it also finds application to other forms of processors. An ASIC may contain one or more megacells which each include custom designed functional circuits combined with pre-designed functional circuits provided by a design library.

An embodiment of the invention may include a system with a processor coupled to a computer readable medium in which a software program is stored that contains instructions that when executed by the processor perform the functions of modules and circuits described herein. The computer readable medium may be memory storage such as dynamic random access memory (DRAM), static RAM (SRAM), read only memory (ROM), Programmable ROM (PROM), erasable PROM (EPROM) or other similar types of memory. The computer readable media may also be in the form of magnetic, optical, semiconductor or other types of discs or other portable memory devices that can be used to distribute the software for downloading to a system for execution by a processor. The computer readable media may also be in the form of magnetic, optical, semiconductor or other types of disc unit coupled to a system that can store the software for downloading or for direct execution by a processor.

As used herein, the terms “applied,” “connected,” and “connection” mean electrically connected, including where additional elements may be in the electrical connection path. “Associated” means a controlling relationship, such as a memory resource that is controlled by an associated port. The terms assert, assertion, de-assert, de-assertion, negate and negation are used to avoid confusion when dealing with a mixture of active high and active low signals. Assert and assertion are used to indicate that a signal is rendered active, or logically true. De-assert, de-assertion, negate, and negation are used to indicate that a signal is rendered inactive, or logically false.

It is therefore contemplated that the appended claims will cover any such modifications of the embodiments as fall within the true scope and spirit of the invention.

What is claimed is:

1. A method for performing multiplication in a digital system having a multiply-shift unit, comprising:
receiving two operands on respective inputs of the multiply-shift unit, wherein one of the operands includes a concatenated encoded shift amount;
multiplying the two operands to form a quotient after separating the concatenated encoded shift amount from the one operand; and
shifting the quotient according to the encoded shift amount to form a shifted quotient on an output of the multiply-shift unit.

2. The method of claim 1, wherein the precision of the concatenated operand is reduced by the size of the encoded shift amount.

3. The method of claim 2, wherein the encoded shift amount is represented by two bits of data.

4. The method of claim 3, wherein the encoded shift amount is selected from a group consisting of +6, +1, 0 and −6.

5. The method of claim 1, further comprising:
determining an amount to shift a quotient of a pair of two operands in order to avoid overflow;
encoding the shift amount; and
concatenating the encoded shift amount with one of the operands.

6. The method of claim 5, wherein the amount to shift a quotient is determined for a plurality of pairs of operands, and wherein the largest determined shift is used for each of the plurality of pairs of operands.

7. The method of claim 5, wherein two or more multiply-shift units receive two operands in parallel, wherein one of the operands of each of the two or more multiply-shift units is a same filter coefficient, and wherein the encoded shift amount is concatenated with the filter coefficient.

8. The method of claim 1, wherein the digital system is a cellular handset.

9. A digital system, comprising:
memory configured to hold operands;
a first multiply-shift unit coupled to the memory and configured to receive a first operand and a second operand from the memory in parallel, wherein the first operand includes a concatenated encoded shift amount, the multiply-shift unit comprising:
a multiplier configured to receive the first operand after being separated from the concatenated encoded shift amount, the multiplier being configured to form a quotient from the two operands; and
a shifter coupled to receive the quotient and to shift the quotient by an amount indicated by the encoded shift amount and to thereby form a shifted quotient on an output of the multiply-shift unit.

10. The digital system of claim 9, wherein the precision of the concatenated operand is reduced by the size of the encoded shift amount.

11. The digital system of claim 9, wherein the encoded shift amount is represented by two bits of data.

12. The digital system of claim 11, wherein the encoded shift amount is selected from a group consisting of +6, +1, 0 and −6.

13. The digital system of claim 9, further comprising at least a second multiply-shift unit coupled in parallel with the first multiply-shift unit to the memory and configured receive two operands from the memory in parallel, wherein a first one of the operands includes a concatenated encoded shift amount.

14. The digital system of claim 13, wherein the first operand received by the first multiply-shift unit and a first operand received by the at least second multiply-shift unit are the same operand.

15. The digital system of claim 9, wherein the multiplier is configured to perform an n×(n−s) multiply, wherein n is the number of bits of the second operand and s is the number of bits of the encoded shift amount.

16. The digital system of claim 9, wherein the multiplier is a floating point multiplier.

17. The digital system of claim 9 being a cellular telephone, further comprising:
radio frequency (RF) transceiver logic coupled to an antenna; and
a digital signal processor coupled to the RF transceiver, the processor configured to receive data samples from the RF transceiver and to store them in the memory, and wherein the digital signal processor comprises the multiply-shift unit.

18. A method for performing multiplication in a digital system having a multiply-shift unit, comprising:
determining an amount to shift a quotient of a pair of two operands in order to avoid overflow;
encoding the shift amount;
concatenating the encoded shift amount with one of the operands; and
storing the operand with the concatenated encoded shift amount in a memory coupled to the multiply-shift unit.

19. The method of claim 18, wherein the encoded shift amount is selected from a group consisting of +6, +1, 0 and −6.

20. The method of claim 18, further comprising:
receiving the two operands on respective inputs of the multiply-shift unit, wherein one of the operands includes the concatenated encoded shift amount;
multiplying the two operands to form a quotient after separating the concatenated encoded shift amount from the one operand; and
shifting the quotient according to the encoded shift amount to form a shifted quotient on an output of the multiply-shift unit.
